(19) United States
(12) Patent Application Publication
(10) Pub. No.: US 2010/0235208 A1
(43) Pub. Date: Sep. 16, 2010

(54) SYSTEM AND METHODS FOR BALANCING BINARY TREES

(76) Inventor: Naim Valensi, Ramat Gan (IL)

Correspondence Address: Naim Valensi, 23 Chibat Tzion Street, Ramat Gan, NA, 52391, omitted

(21) Appl. No.: 12/703,796

(22) Filed: Feb. 11, 2010

Related U.S. Application Data
(60) Provisional application No. 61/159,454, filed on Mar. 12, 2009.

(51) Int. Cl. G06Q 10/00

(52) U.S. Cl. 705/7; 705/348

(57) ABSTRACT

Systems and methods for balancing the length of the down-line legs of the binary tree of a distributor in an MLM organization, and providing at least two down-line customers to each of the distributor's customers. The method for adding a new member to an organizational head being part of an MLM organization, includes identifying the node in the MLM organizational binary tree representing the organizational head, thereby determining the current root node, determining the primary side and the secondary side of the binary tree of the root node, and determining the number of children of the root node. Upon determining the number of children to be zero, creating a new leg with a new node at the primary side of the root node. Upon determining the number of children to be one, creating a new leg with a new node at the secondary side of the root node. Upon determining the number of children to be two, determining the next root node.

### CROSS-REFERENCE TO RELATED APPLICATIONS

The present application claims the benefit under 35 U.S.C. 119(e) of U.S. provisional application 61/159,454 filed on Mar. 12, 2009, the disclosure of which is incorporated herein by reference.

### FIELD OF THE INVENTION

The present invention relates generally to binary trees, and more particularly to methods and a system for balancing binary trees.

### BACKGROUND OF THE INVENTION AND PRIOR ART

Individuals of a multi-level marketing (MLM) system are often referred to as distributors, field representatives, salespeople, etc. (referred to herein as “distributors”), and are rewarded with a commission relative to the volume of products and/or services sold through each of their independent businesses. It should be noted that an individual can be characterized in many different ways. For example, an individual can be a single person or a group of people. Furthermore, an individual can be a single entity, such as a business, or multiple businesses. Individuals develop their organizations by either building an active customer base, which customers buy directly from the parent company and/or by recruiting a down-line of independent distributors, each of which also build a customer base, which independent distributors expands the overall organization.

Distributors earn a commission based on the sales efforts of their organization, which includes the distributors' independent sales efforts as well as the leveraged sales efforts of the distributors' down-line. This arrangement is similar to franchise arrangements in which royalties are paid from the sales of individual franchise operations to the franchiser as well as to an area or region manager. Commissions are paid to MLM distributors according to the company's compensation plan. There can be multiple levels of people receiving royalties or commissions from one person's sales.

A distributor may keep down line customers in a binary tree structure, which represents the distributor's organization, wherein the distributor heads the binary tree (BT) and the customers are kept in two down-line legs. Each down-line customer/distributor also keeps two down-line legs. Typically, each distributor and each customer-distributor are typically rewarded for each sale of their own down-line customer-distributors positioned on their shortest down-line leg, provided that they have at least two customers. The distributor and each customer are herein referred to as “organizational member”. An organizational member refers to his/her immediate organizational head as the “sponsor” distributor.

In order to maximize the earnings from the shorter leg, it is the incentive of each organizational member to balance the length of his/her down-line legs. It is a further incentive for the distributor to maximize the earnings of his/her customer-distributors by providing at least two down-line customers to each of the distributor's down-line customers.

There is therefore a need and it would be advantageous to provide a system and methods for balancing the length of the down-line legs of the binary tree of each organizational member. It would be further advantageous for the distributor to provide at least two down-line customers to each of the distributor's down-line customer-distributors.

The term “down-line” used with association to a particular node in a binary tree, as used herein, refers to nodes in the binary tree that is accessible from the particular node, going down the tree from the particular node. For example, referring to FIG. 4, which shows an example binary tree, all customers (1-62) are down-line nodes of the node representing a distributor 320. Nodes 7, 3, 1, 320 and 310 are down-line to node 15.

The term “up-line” used with association to a particular node in a binary tree, as used herein, refers to nodes in the binary tree that is accessible from the particular node, going up the tree from the particular node. For example, in FIG. 4, the sponsor 310 an up-line node of distributor 320. Nodes 31 and 47 are up-line to node 15.

The term “N^{th} generation” used with reference to a particular node in a binary tree, as used herein, refers to the distance of a down-line node from the particular node. For example, in FIG. 4, node 1 is a first generation 340 of distributor 320. Nodes 31 and 47 are fifth generation 380 of distributor 320.

### BRIEF SUMMARY OF THE INVENTION

The principal intention of the present invention includes providing systems and methods for balancing the length of the down-line legs of each organizational member in an MLM organizational binary tree. Furthermore, the system seeks to provide at least two down-line customers to each of his/her down-line customers.

According to the teachings of the present invention there is provided a method for adding a new member to an organizational head being part of an MLM organizational binary tree, the organizational head having a sponsor including a left leg and a right leg, the method including the steps of:
(a) identifying the node in the MLM organizational binary tree representing the organizational head, thereby determining the current root node having a right side and a left side;
(b) determining the primary side and the secondary side of the binary tree of the root node; and
(c) determining the number of children of the root node. Upon determining the number of children to be zero (0), creating a new leg with a new node at the primary side of the root node. Upon determining the number of children to be one (1), creating a new leg with a new node at the secondary side of the root node. Upon determining the number of children to be two (2), determining the next root node and performing steps (b) and (c).

Optionally, the determining of the primary side and the secondary side of the binary tree of the root node includes determining on which leg of the sponsor the root node is disposed, wherein upon determining that the root node is disposed on the right leg of the sponsor node, assign the right side as the primary side and the left side as the secondary side, and wherein upon determining that the root node is disposed on the left leg of the sponsor node, assign the left side as the primary side and the right side as the secondary side.

Optionally, the determining the next root node includes computing the length of each of the two legs of the root node, and comparing the lengths of the legs of the root node. Upon determining that the lengths are equal, select the next root node to be the node on the primary side of the root node. Upon determining that the lengths are not equal, select the next root node to be the node on the shortest leg of the root node.

An aspect of the present invention is to provide a method that seeks to fulfill the following objectives:
a) elongate the shortest of the two legs of the binary tree of a distributor; and
b) assign at least two customers to each existing customer in the binary tree of the distributor.

An aspect of the present invention is to provide a system for managing an MLM organizational binary tree, facilitating a distributor, being a member of the MLM organization, to add a new member to, the system including a new customers' placement server. The server includes a distributors' manager, a processing unit and a database. The database includes organizational binary trees of respective distributors. The distributors' manager is configured to facilitate the distributor to access his/her organizational binary tree, the binary tree having a left leg and a right leg. The processing unit generates an electromagnetic signal carrying computer readable instructions for adding a new member to the organizational binary tree of the distributor, wherein the computer readable instructions carry out a method configure to equalize the lengths of the left leg and the right leg, and to assign at least two customers to each existing customer in the binary tree. Preferably, the method carried out by the computer readable instructions is the method described hereinabove.

### BRIEF DESCRIPTION OF THE DRAWINGS

The present invention will become fully understood from the detailed description given herein below and the accompanying drawings, which are given by way of illustration and example only and thus not limitative of the present invention, and wherein:

FIG. 1 is a schematic block diagram illustration of a new customer placement system for an MLM organization, according to embodiments of the present invention;

FIG. 2 is a schematic flow chart showing an example method for balancing an MLM organizational binary tree, according to embodiments of the present invention;

FIG. 3 is a schematic flow chart showing an example method for selecting a primary side and a secondary side in accordance with various aspects set forth herein;

FIG. 4 illustrates an example customers binary tree, according to variations of the present invention, wherein the distributor is disposed on the right leg of the distributor's sponsor; and

FIG. 5 illustrates an example customers' binary tree, according to variations of the present invention, wherein the distributor is disposed on the left leg of the distributor's sponsor.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided, so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The methods and examples provided herein are illustrative only and not intended to be limiting.

By way of introduction, the principal intention of the present invention includes providing systems and methods for balancing the length of the down-line legs of each organizational member in an MLM organizational binary tree. Furthermore, the system seeks to provide at least two down-line customers to each of his/her down-line customers.

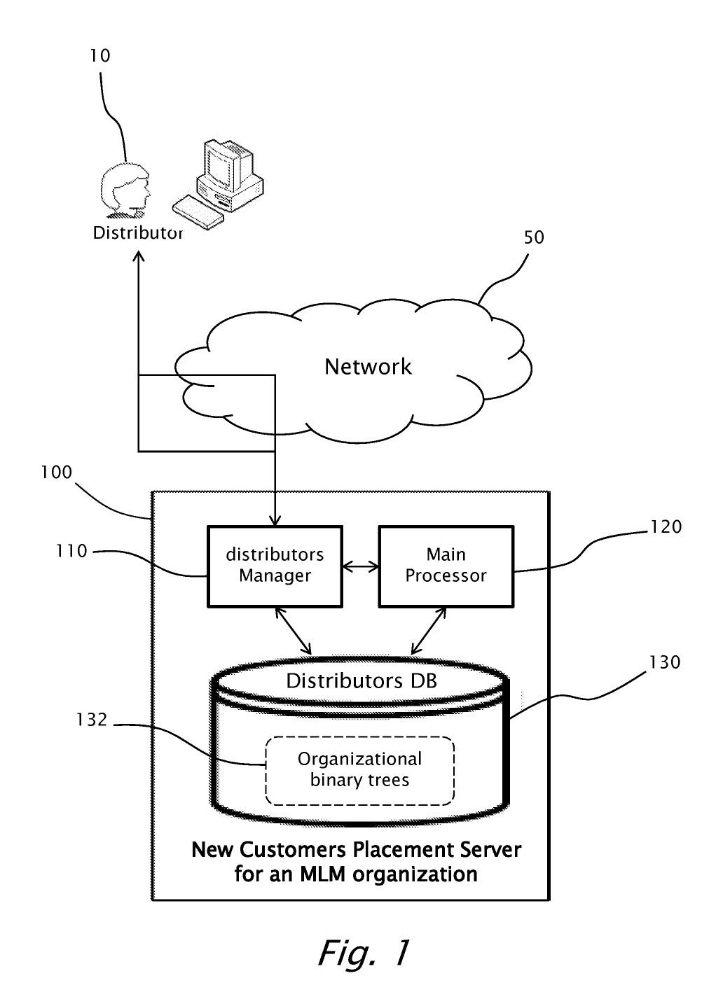

Reference is now made to FIG. 1, which is a schematic block diagram illustration of a new customer placement system 100 for an MLM organization, according to embodiments of the present invention. New customer placement system 100 is a computerized server including customers' management unit 110, main processing unit 120 and DB unit 130. Database unit 130 includes one or more organizational customer binary trees 132, a customer binary tree for each distributor.

When distributor 10 wants to add a new customer to his/her organizational binary tree, distributor 10 logs into new customer placement system 100, directly or over a network 50 such as an internet network or a cellular network, and enters the details of the new customer to be added to the organizational binary tree. Main processing unit 120 generates an electromagnetic signal carrying computer readable instructions, for best balancing the binary tree of distributor 10. The computer readable instructions carry out a method that seeks to fulfill the following objectives:
c) elongate the shortest of the two legs of the binary tree of distributor 10; and
d) assign at least two customers to each existing customer in the binary tree of distributor 10.

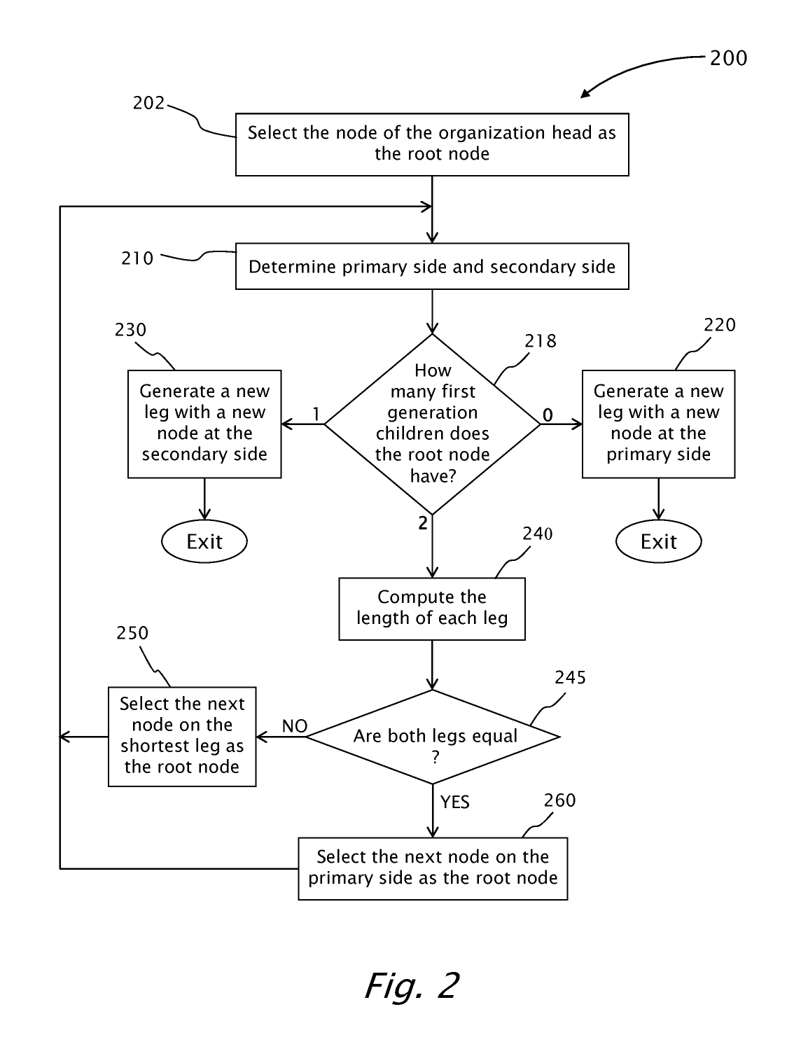

Reference is also made to FIG. 2, which is a schematic flow chart showing an example method 200 adding a new member to an organizational head being part of an MLM organizational binary tree, according to embodiments of the present invention.

When a distributor 10 introduces a new customer to new customer placement system 100, new customer placement system 100 first identifies and selects (step 202) the node in an organizational binary tree that represents the distributor 10 (the “organizational head”), thereby determining the process root node. The balancing is carried out on a segment binary tree of the overall organizational binary tree, wherein the binary tree segment represents the organization of the organizational head.

Method 200 proceeds as follows:

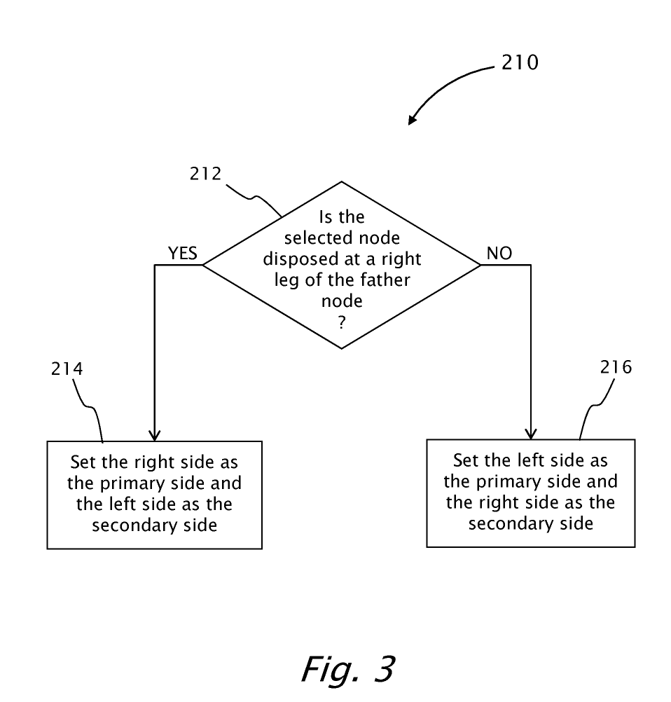

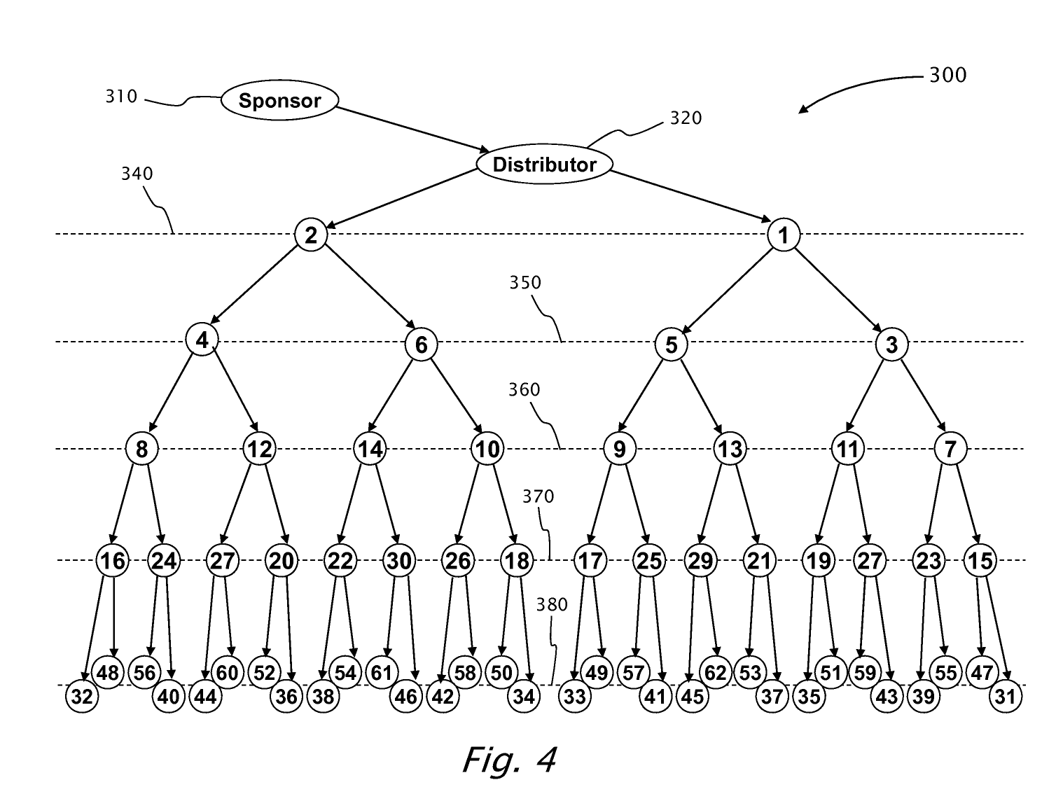

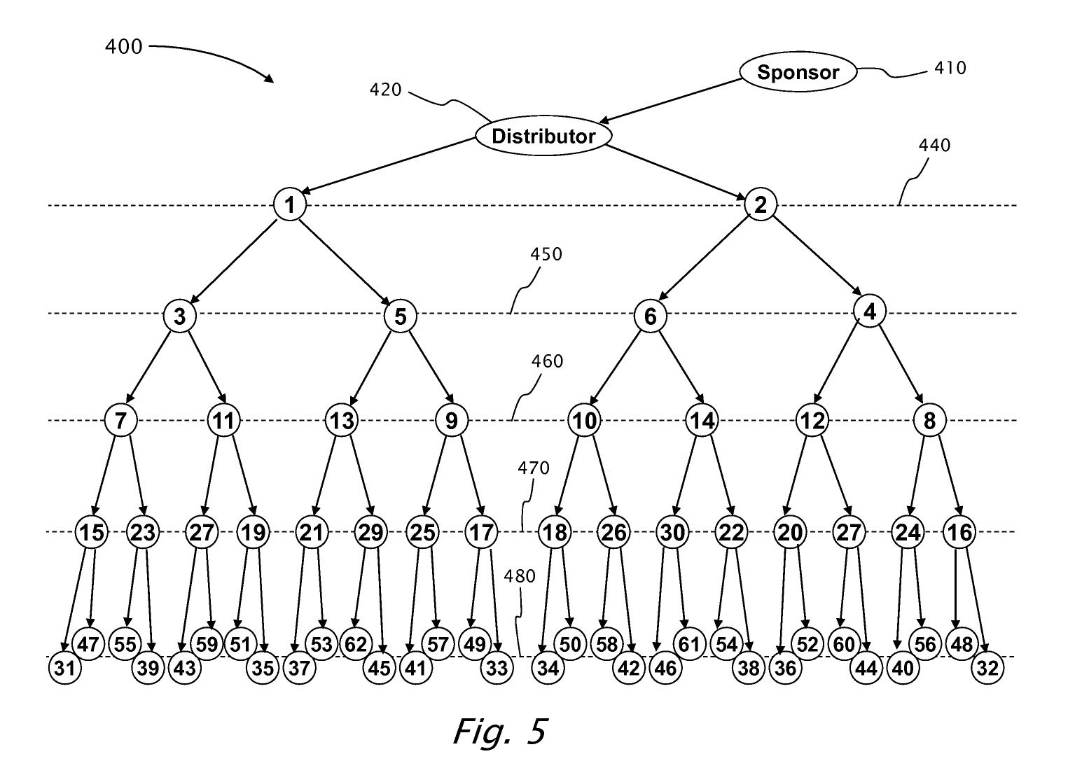

Step 210: determining the primary side and secondary side of the binary tree of the root node.
The primary side and secondary side of the binary tree of the root node are determined according to the side of the leg the sponsor (up-line) of the distributor represented by the root node, on which leg the root node is disposed. Reference is also made to FIGS. 4 and 5, which illustrate examples of customers' binary trees, wherein the node representing distributor 10 is respectively disposed either on the right or left legs of the sponsor of distributor 10.
FIG. 4 illustrate binary tree 300, wherein distributor 320 is disposed on the right leg of sponsor 310 of distributor 320. Thereby, the primary side is determined to be the right side and the secondary side is determined to be the left side. FIG. 5 illustrate binary tree 400, wherein distributor 420 is disposed on the left leg of sponsor 410 of distributor 420. Thereby, the primary side is determined to be the left side and the secondary side is determined to be the right side.
Reference is also made to FIG. 3, which is a schematic flow chart elaborating step 210 of determining the primary side and the secondary side of the root node.
Step 212: check the position of the father node of the root node.
   Determining the leg positioning of the father node of the root node:
   if the root node is disposed on the right leg of the father node, go to step 214.
   if the root node is disposed on the left leg of the father node, go to step 216.
Step 214: set the right side as the primary side and the left side as the secondary side of the root node.
   It has been determined that the root node is disposed on the right leg of the father node. Hence, assign the right side as the primary side and the left side as the secondary side of the root node.
Step 216: set the left side as the primary side and the right side as the secondary side of the root node.
   It has been determined that the root node is disposed on the left leg of the father node. Hence, assign the left side as the primary side, and the right side as the secondary side of the root node.
      Step 218: determining how many first generation children does the root node have.
Determine if the root node has children.
If the root node has no children, go to step 220.
If the root node has one child, go to step 230.
If the root node has two children, go to step 240.
   Step 220: the root node has no children.
The root node has no children. Thereby, generate a new leg with a new node at the primary side of the root node, and terminate procedure 200.
   Step 230: the root node has one child.
The root node has one child, which is disposed on the primary side of the root node. Thereby, generate a new leg with a new node at the secondary side of the root node, and terminate procedure 200. The root node now has the desired minimum two children, being the first generation children of the root node.
   Step 240: compute the length of each leg of the root node.
The root node has two legs and thereby, two first generation children. At step 240 of method 200 the length of each leg is computed, wherein the length of a leg represents the number of children (customers) from which children each leg is composed.

### EXAMPLES

Referring back to FIG. 4:
a) If the root node is the node of distributor 320, the number of children on each leg is 31.
b) If the root node is of a second generation (350) of distributor 320, marked with the sequential number 3, the number of children on each leg of the root node is 7.
c) If the root node is of a fourth generation (370) of distributor 320, marked with the sequential number 15, the number of children on each leg of the root node is 1.
   Step 245: check if both legs are equal.

Determine if both legs of the root node are equal.

If both legs of the root node are equal, go to step 260.

Step 250: select the next node on the shortest leg.
Select the next “root node” to be the node on the shortest leg of the currently selected root node, representing a first generation child of the currently selected root node.
Go to step 210.
   Step 260: select the next node on the primary side.
Select the next “root node” to be the node on the primary side of the currently selected root node.
Go to step 210.
   For example, in the example shown in FIGS. 4 and 5, the next new customer will be placed on the primary side of the fifth generation node marked with the sequential number 31, and will carry the sequential number 63.

An aspect of the present invention is to provide a new customer placement system 100 for an MLM organization that facilitates balancing the binary tree of a distributor 10 when a customer of distributor 10 independently adds a new customer.

The invention being thus described in terms of embodiments and examples, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for adding a new member to an organizational head being part of an MLM organizational binary tree, the organizational head having a sponsor including a left leg and a right leg, the method comprising the steps of:
(a) identifying the node in said MLM organizational binary tree representing said organizational head, thereby determining the current root node having a right side and a left side;
(b) determining the primary side and the secondary side of the binary tree of said root node; and
(c) determining the number of children of said root node, wherein upon determining said number of children to be zero (0), creating a new leg with a new node at said primary side of said root node; wherein upon determining said number of children to be one (1), creating a new leg with a new node at said secondary side of said root node; and wherein upon determining said number of children to be two (2), determining the next root node and performing steps (b) and (c).

2. The method of claim 1, wherein in said determining of said primary side and said secondary side of said binary tree of said root node comprises the step of:
(a) determining on which leg of said sponsor said root node is disposed,
wherein upon determining that said root node is disposed on said right leg of said sponsor node, assign said right side as said primary side and said left side as said secondary side; and
wherein upon determining that said root node is disposed on said left leg of said sponsor node, assign said left side as said primary side and said right side as said secondary side.

3. The method of claim 1, wherein in said determining the next root node comprises the steps of:
(a) computing the length of each of the two legs of said root node; and
(b) comparing said lengths of said legs of said root node,
wherein upon determining that said lengths are equal, select the next root node to be the node on said primary side of said root node; and
wherein upon determining that said lengths are not equal, select the next root node to be the node on the shortest leg of said root node.

4. A system for managing an MLM organizational binary tree, facilitating a distributor, being a member of the MLM organization, to add a new member to, the system comprising a new customers placement server, wherein said server comprises:
a) a distributors' manager;
b) a processing unit; and
c) a database,
wherein said database comprises organizational binary trees of respective distributors;
wherein said distributors' manager is configured to facilitate said distributor to access his/her organizational binary tree, said binary tree having a left leg and a right leg; and
wherein said processing unit generates an electromagnetic signal carrying computer readable instructions for adding a new member to said organizational binary tree of said distributor, wherein said computer readable instructions carry out a method configured to equalize the lengths of said left leg and said right leg, and to assign at least two customers to each existing customer in said binary tree.

5. The system of claim 4, wherein in said method is a method as in claim 1.
